(19) United States
(12) Patent Application Publication
(10) Pub. No.: US 2016/0188104 A1
(43) Pub. Date: Jun. 30, 2016

(54) POSITION DETECTING DEVICE

(71) Applicant: Wacom Co., Ltd., Saitama (JP)

(72) Inventor: Yuji Katsurahira, Saitama (JP)

(21) Appl. No.: 15/065,697

(22) Filed: Mar. 9, 2016

Related U.S. Application Data
(63) Continuation of application No. PCT/JP2014/073899, filed on Sep. 10, 2014.

(30) Foreign Application Priority Data
Sep. 27, 2013 (JP) 2013-200911

(51) Int. Cl. G06F 3/041; G06F 3/044; G06F 3/047

(52) U.S. Cl. CPC G06F 3/0416; G06F 3/047; G06F 3/044; G06F 3/0412; G06F 2203/04104

(57) ABSTRACT

A position detecting device enables input at multiple points by multiple fingers without being susceptible to noise. A transmission signal generating circuit outputs a signal to a predetermined electrode among electrodes arranged in a first direction of a position detecting sensor. At least four adjacent electrodes are selected from among electrodes arranged in a second direction orthogonal to the first direction of the position detecting sensor. One half of the selected electrodes are connected to a first input terminal of a differential amplifier circuit. A remaining half of the selected electrodes are connected to a second input terminal of the differential amplifier circuit. Whether an indicator placed on the position detecting sensor is present on an electrode connected to the differential amplifier circuit is determined according to the polarity of an output signal of a synchronous detection circuit that synchronously detects the output of the differential amplifier circuit.

### BACKGROUND

1. Technical Field

The present disclosure relates to a position detecting device that detects a plurality of positions indicated by conductors such as fingers or the like by a capacitive system, and particularly to a technology that detects positions indicated by a plurality of indicators on a position detecting sensor and which improves detection accuracy by reducing noise mixed into the position detecting sensor.

2. Description of the Related Art

Tablet type information terminals including a touch panel have recently come into wide use. The innovation of a multi-touch technology for simultaneously inputting a plurality of finger positions, in particular, has been progressing.

As a technology of this kind, as disclosed in Patent Document 1 (Japanese Patent Laid-Open No. H08-179871), for example, a capacitive induction system is widely used which sequentially selects points of intersection formed by a plurality of electrodes arranged vertically and horizontally on a panel surface, obtains signal strengths, and obtains a finger position according to the signal distribution of the signal strengths. A device of Patent Document 1 detects a signal corresponding to a finger placed in the vicinity of a point of intersection formed by a selected vertical line and a selected horizontal line. Thus, even when a plurality of fingers are simultaneously placed on the panel, the positions of the respective fingers can be obtained accurately without the signals interfering with each other.

The above-described device is often used in combination with a display device such as a liquid crystal display (LCD) or the like. In that case, noise caused by the display device is mixed in. Therefore, it is often that a finger position cannot be obtained correctly, or a wrong position is detected, which causes erroneous operation. Capacitive induction type touch panels therefore present an important challenge of noise removal.

A differential amplifier has been used as a most effective method for removing noise. Specifically, by simultaneously selecting two electrode lines, and connecting one of the two electrode lines to a positive side input and connecting the other to a negative side input, noise components are canceled out to detect only a signal difference caused by the approaching of a finger. Concrete examples of the method include for example technologies described in Patent Document 2 (Japanese Patent Laid-Open No. H05-6153) and Patent Document 3 (Japanese Patent Laid-Open No. H10-20992) or the like.

However, the above-described detection based on differential input has not been put to practical use in multi-touch panels that detect a plurality of fingers simultaneously. A reason for this is that with differential input, the approaching of a finger can always be detected at a plurality of points and therefore even if signals are detected, it is difficult to determine points on which fingers are placed. The invention of Patent Document 4 (Japanese Patent Laid-Open No. 2011-8723) has been proposed as a technology for solving such a problem.

In a position detecting device described in this Patent Document 4, each receiving electrode is divided into three electrodes, and the central electrode is connected to the positive side input terminal of a differential amplifier and the electrodes on both sides are connected to the negative side input terminal of the differential amplifier. The position detecting device is thus configured to be able to cancel noise, and detect a change when a finger touches.

### PRIOR ART DOCUMENTS

### Patent Documents

Patent Document 1: Japanese Patent Laid-Open No. H08-179871

Patent Document 2: Japanese Patent Laid-Open No. H05-6153

Patent Document 3: Japanese Patent Laid-Open No. H10-20992

Patent Document 4: Japanese Patent Laid-Open No. 2011-8723

### BRIEF SUMMARY

### Technical Problems

In many position detecting devices of this kind, a sensor having a plurality of electrodes arranged therein is formed with a transparent glass, a PET film, or the like, and is connected to a circuit board mounted with an analog switch for selecting electrodes, a differential amplifier, and the like by an anisotropic conductive film (ACF) connection, a connector, or the like. In this case, the larger the number of connections between the sensor and the circuit board, the higher the cost of the device, and the higher a failure rate. The above-described example of Patent Document 4 has a problem of a large number of connections between the sensor and the circuit board because one conventional electrode is divided into three electrodes.

In another embodiment (FIG. 11) described in Patent Document 4, receiving electrodes having a uniform thickness are arranged, among which a plurality of electrodes are selected as a positive side, and electrodes on both sides of the plurality of electrodes are selected as a negative side, so that an attempt is made to realize an effect similar to that described above. For this purpose, however, a pitch at which the receiving electrodes are arranged needs to be sufficiently smaller than the width of a contact surface contacted by a finger, and the problem of a large number of connections between the sensor and the circuit board still remains.

In addition, the position detecting device of Patent Document 4 has another problem in that with an increase in size of the position detecting device, a sampling rate is decreased due to an increase in the number of electrodes.

In view of the problems as described above, it is an object of the present disclosure to provide a multi-touch panel (position detecting device) that enables input at a plurality of points by a plurality of fingers and which enables stable input without being susceptible to noise.

In addition to the above-described object, it is an object of the present disclosure to provide a low-cost and high-reliability multi-touch panel (position detecting device) by reducing the number of connections between a position detecting sensor and a circuit board.

It is another object of the present disclosure to provide a multi-touch panel (position detecting device) that enables input by a plurality of fingers to be performed stably at a high sampling rate without being affected by noise even when the size of the position detecting device is increased.

### Technical Solution

In order to achieve the above objects, the present disclosure proposes a position detecting device having the following constitution.

The position detecting device is provided with: a position detecting sensor having a plurality of electrodes arranged in a first direction and a plurality of electrodes arranged in a second direction orthogonal to the first direction; a transmission signal generating circuit supplying a transmission signal to the electrodes arranged in the first direction; and a first electrode selecting circuit that supplies the transmission signal output from the transmission signal generating circuit to a predetermined electrode among the plurality of electrodes arranged in the first direction.

The position detecting device is provided with: a differential amplifier circuit that has a first input terminal and a second input terminal, and that outputs a received signal obtained by differentially amplifying signals input to the first input terminal and the second input terminal; and a second electrode selecting circuit that selects a number of electrodes adjacent to each other among the plurality of electrodes arranged in the second direction, the number of electrodes adjacent to each other being at least four or more, and being an even number and a predetermined number, and supplies one half of the even number of electrodes selected, the one half being electrodes adjacent to each other exclusive of electrodes at both ends, to the first input terminal of the differential amplifier circuit, and that supplies a remaining half of the even number of electrodes selected, the remaining half including the electrodes at both ends, to the second input terminal of the differential amplifier circuit.

The position detecting device is provided with: a synchronous detection circuit that detects a strength of the received signal output by the differential amplifier circuit, and outputs the received signal as a value in a positive direction or a negative direction according to a phase of the received signal with respect to a phase of the transmission signal; and a processing circuit that determines a position indicated by an indicating conductor a finger or the like according to a distribution of the strength of the signal output by the synchronous detection circuit and a polarity of the signal output by the synchronous detection circuit, the polarity being expressed as positive or negative polarity, when the electrodes selected by the first electrode selecting circuit and the second electrode selecting circuit are sequentially changed.

In the thus configured position detecting device according to the disclosure, when an indicator such as a finger or the like is placed on respective points of intersection of the two sets of receiving electrodes connected to the first input terminal and the second input terminal and the transmitting electrode selected by the first electrode selecting circuit, a signal appears in the output of the differential amplifier circuit. The position detecting device according to the present disclosure can determine whether the placed indicator is present on an electrode connected to the first input terminal of the differential amplifier circuit or an electrode connected to the second input terminal of the differential amplifier circuit, according to the polarity of the signal appearing in the output of the synchronous detection circuit.

In addition, the electrodes connected to the first input terminal side of the differential amplifier circuit are selected such that the number of electrodes adjacent to each other among the electrodes connected to the first input terminal side of the differential amplifier circuit is larger than the number of electrodes adjacent to each other among the electrodes connected to the second input terminal side of the differential amplifier circuit. A strong signal can therefore be detected when receiving electrodes in the vicinity of the indicator are selected as the first input terminal side.

In addition, because the electrodes connected to the second input terminal side of the differential amplifier circuit are arranged in a distributed manner, a high degree of effect of canceling external noise from a liquid crystal or the like is obtained.

The present disclosure further proposes the position detecting device in which the processing circuit performs processing so as to regard, as valid, a direction of the output polarity from the synchronous detection circuit when the indicator is placed on an electrode connected to the first input terminal of the differential amplifier circuit by the second electrode selecting circuit, and regard, as invalid, a direction of the output polarity from the synchronous detection circuit when the indicator is placed on an electrode connected to the second input terminal of the differential amplifier circuit by the second electrode selecting circuit.

The present disclosure further proposes the position detecting device in which, in a case where a direction of the output polarity from the synchronous detection circuit when the indicating conductor is placed on an electrode connected to the first input terminal of the differential amplifier circuit by the second electrode selecting circuit is positive, and the direction of the output polarity from the synchronous detection circuit when the indicating conductor is placed on an electrode connected to the second input terminal of the differential amplifier circuit by the second electrode selecting circuit is negative, when a distribution of output voltage from the synchronous detection circuit when the electrodes selected by the second electrode selecting circuit are updated in order while the first electrode selecting circuit is selecting a particular electrode has two peak points in the positive direction, and a point as a voltage in the negative direction and of a predetermined magnitude or more is present between the two peak points, the two peak points are judged to result from respective independent indicators, and when a point as a predetermined voltage or higher in the negative direction is not present between the two peak points, the two peak points are judged to result from an identical indicator.

By performing such processing, it is possible to clearly distinguish two indicators from each other even when the two indicators are placed in proximity to each other, and correctly determine an indicator straddling a wide region.

The present disclosure further proposes the position detecting device in which the position detecting device is combined with a display device such as a liquid crystal display device or the like, and a transparent conductive material is used as the electrodes of the position detecting sensor.

In order to achieve another object of performing detection at a high sampling rate and with a high resistance to noise even with an increase in size, the present disclosure proposes a position detecting device including a position detecting sensor including a plurality of transmitting electrodes arranged in a first direction of a position detecting surface and a plurality of receiving electrodes arranged in a second direction orthogonal to the first direction, the position detecting device detecting a signal corresponding to a change in capacitance between the transmitting electrodes and the receiving electrodes when a conductor such as a finger or the like comes into contact with the position detecting surface, the position detecting device having the following constitution.

A plurality of signal processing circuits each connected to a predetermined number of electrodes among the plurality of receiving electrodes is provided.

The plurality of signal processing circuits each include an electrode selecting circuit selecting two sets of electrodes from among the predetermined number of connected receiving electrodes and outputting the two sets of electrodes as a positive terminal and a negative terminal, and a differential amplifier circuit connected to the positive terminal and the negative terminal, the differential amplifier circuit detecting a signal difference.

The position detecting surface is divided into a plurality of regions in the second direction and the receiving electrodes are connected to the plurality of signal processing circuits in each region, and a particular number of receiving electrodes located in a vicinity of a boundary between regions are commonly connected to two signal processing circuits. In addition, these signal processing circuits are desirably operated simultaneously.

### Advantageous Effect

The position detecting device according to the present disclosure can cancel external noise by the differential amplifier circuit, and determine whether the indicator is present on an electrode connected to the first input terminal of the differential amplifier circuit or an electrode connected to the second input terminal of the differential amplifier circuit, according to the polarity of the signal appearing in the output of the synchronous detection circuit. Thus, a conventional problem of detecting one indicator as a plurality of positions can be solved, and when indicators are placed in a plurality of positions, these positions can be detected correctly.

According to the present disclosure, the position detecting surface is divided into a plurality of regions, and processing is performed by a plurality of signal processing circuits. Thus, even in a case of a wide position detecting surface, the signals of the receiving electrodes can be processed in parallel by a plurality of differential amplifiers, so that detection can be performed at a high sampling rate.

In addition, a particular number of receiving electrodes located in the vicinity of a boundary between regions are commonly connected to two signal processing circuits. Thus, signals are detected in the same manner as in a case of a continuous detecting surface as a whole. In addition, even when each individual signal processing circuit is configured as an integrated circuit (IC), processing can be performed with the divided position detecting surface treated as a continuous detecting surface, without the presence of a non-sensitive region.

In addition, an operation of changing the area of the selected receiving electrodes by one electrode can be performed. Thus, an indicated position can be determined minutely even when an electrode arrangement pitch is increased, and the number of connections between the position detecting sensor and the circuit board can be reduced. A low-cost and high-reliability touch panel can therefore be realized.

### BRIEF DESCRIPTION OF THE SEVERAL VIEWS OF THE DRAWINGS

FIG. 1 is a diagram showing a constitution of a position detecting section in a first embodiment of a position detecting device according to the present disclosure.

FIG. 2 is a sectional view of an example of a transparent sensor used in the first embodiment of the position detecting device according to the present disclosure.

FIG. 3 is a block diagram of the first embodiment of the position detecting device according to the present disclosure.

FIG. 4 is a diagram showing a basic operation mode of the first embodiment of the position detecting device according to the present disclosure.

FIGS. 5(A) and 5(B) are diagrams showing a difference between received signals according to a position indicated by a conductor in the first embodiment of the position detecting device according to the present disclosure.

FIG. 6 is a diagram in a case where an indicating conductor is present in a position straddling an electrode X4 and an electrode X5 in the first embodiment of the position detecting device according to the present disclosure.

FIG. 7 is a diagram in a case where there is a large indicating conductor straddling electrodes X4 to X8 in the first embodiment of the position detecting device according to the present disclosure.

FIG. 8 is a diagram in a case where there are indicating conductors on electrodes X4 and X5 and on electrodes X7 and X8 in the first embodiment of the position detecting device according to the present disclosure.

FIG. 9 is a diagram in a case where there is an indicating conductor straddling a plurality of X-electrodes and Y-electrodes in the first embodiment of the position detecting device according to the present disclosure.

FIG. 10 is a diagram showing a signal polarity distribution in FIG. 9.

FIG. 11 is a diagram showing another example in which there are indicating conductors straddling a plurality of Y-electrodes in the first embodiment of the position detecting device according to the present disclosure.

FIG. 12 is a diagram showing a signal polarity distribution in FIG. 11.

FIG. 13 is a block diagram of a second embodiment of a position detecting device according to the present disclosure.

### DETAILED DESCRIPTION

### First Embodiment

### First Mode

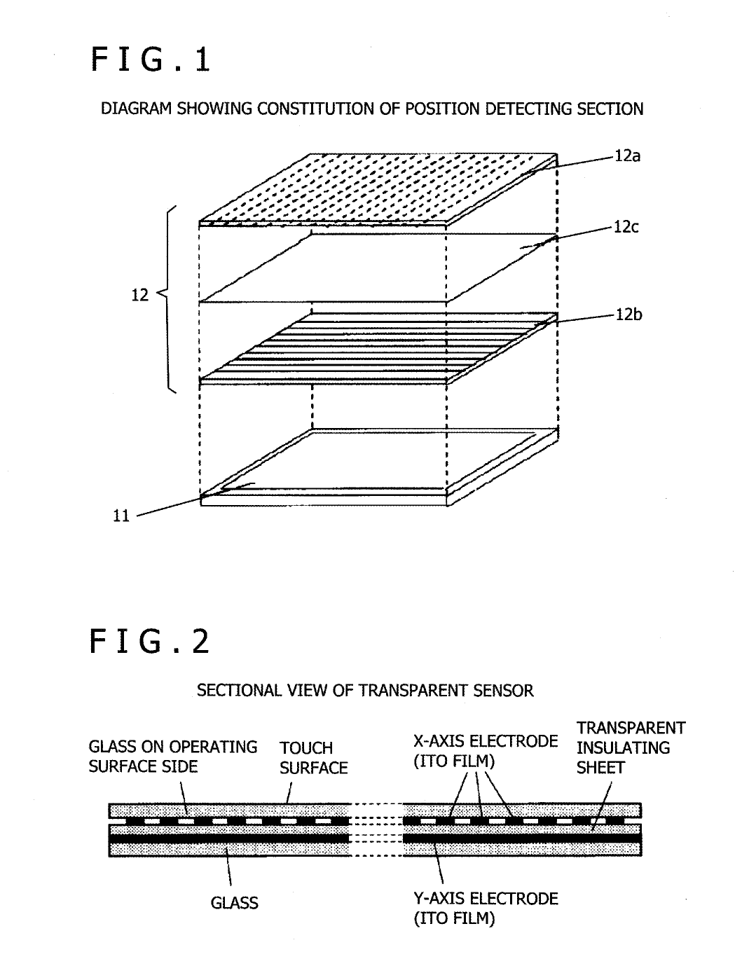

FIG. 1 is a diagram showing a configuration of a position detecting section according to a first embodiment of a position detecting device according to the present disclosure. In the figure, reference numeral 11 denotes an LCD panel. Reference numeral 12 denotes a transparent sensor having electrodes formed of indium tin oxide (ITO). Reference numeral 12a denotes an ITO glass formed with a plurality of lines of ITO electrodes arranged in an X-direction. Reference numeral 12b denotes an ITO glass formed with a plurality of lines of ITO electrodes arranged in a Y-direction. Reference numeral 12c denotes a polyethylene terephthalate (PET) film having a uniform thickness. The transparent sensor 12 is produced by bonding the ITO glass 12a and the ITO glass 12b to each other with respective ITO surfaces of the ITO glass 12a and the ITO glass 12b facing each other and with the PET film 12c interposed between the ITO glass 12a and the ITO glass 12b. The transparent sensor 12 is disposed so as to be superposed on the LCD panel 11 such that the detecting region of the transparent sensor 12 precisely coincides with the display region of the LCD panel 11. Incidentally, the X-electrodes on the ITO glass 12a and the Y-electrodes on the ITO glass 12b are connected to a printed board not shown in the figure via a flexible board not shown in the figure by an ACF connection. FIG. 2 is a sectional view obtained by cutting the transparent sensor 12 along a Y-electrode.

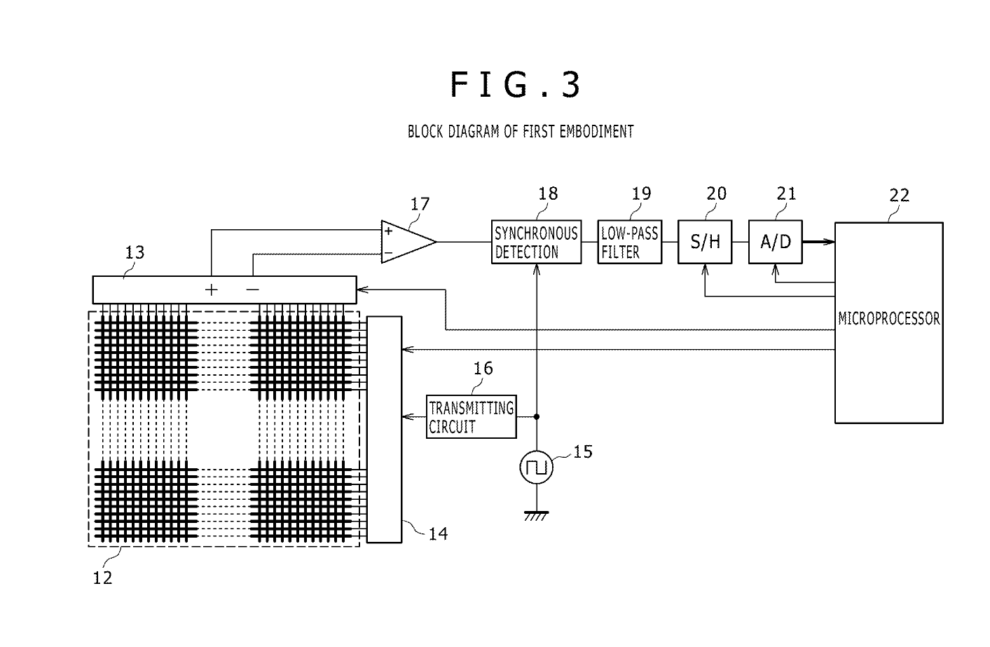

FIG. 3 is a block diagram of the first embodiment of the position detecting device according to the present disclosure. In FIG. 3, reference numeral 12 denotes the transparent sensor. Reference numeral 13 denotes an X-selecting circuit that is connected to the X-electrodes of the transparent sensor 12 and which selects two sets of electrodes as a positive terminal and a negative terminal from among the X-electrodes. Reference numeral 14 denotes a Y-selecting circuit that is connected to the Y-electrodes of the transparent sensor 12 and which selects one (or a plurality of adjacent electrodes) from among the Y-electrodes. The present embodiment will be described supposing that there are 40 X-electrodes (X0 to X39), and that there are 30 Y-electrodes (Y0 to Y29).

Reference numeral 15 denotes an oscillator that oscillates at a predetermined frequency. The output signal of the oscillator is supplied to a transmitting circuit 16. The transmitting circuit 16 is a circuit that outputs a signal from the oscillator 15 after converting the signal into a predetermined voltage. The output signal is applied to a Y-electrode selected by the Y-selecting circuit 14.

Reference numeral 17 denotes a differential amplifier. The first input terminal and the second input terminal (the non-inverting input terminal (+) and the inverting input terminal (−)) of the differential amplifier are connected to the positive terminal and the negative terminal selected by the X-selecting circuit 13. Reference numeral 18 denotes a synchronous detection circuit. The synchronous detection circuit 18 is connected to the respective output terminals of the differential amplifier 17 and the oscillator 15. The synchronous detection circuit 18 outputs a signal obtained by synchronous detection of an output signal from the differential amplifier 17 on the basis of the signal from the oscillator 15. The synchronous detection circuit 18 synchronously detects the output signal of the differential amplifier 17 on the basis of the signal (transmission signal) from the oscillator 15, and detects the strength of the output signal of the differential amplifier 17. The synchronous detection circuit 18 outputs a result of the detection as a value in a positive direction or a negative direction according to the phase of the output signal of the differential amplifier 17 with respect to the phase of the signal (transmission signal) from the oscillator 15. The output signal of the synchronous detection circuit 18 is smoothed by a low-pass filter 19, and is then sampled and held by a sample and hold circuit 20. Further, an analog to digital (AD) converting circuit 21 digitizes the signal strength.

The digital data converted by the AD converting circuit 21 is read and processed by a microprocessor 22. The microprocessor 22 supplies control signals to the X-selecting circuit 13, the Y-selecting circuit 14, the sample and hold circuit 20, and the AD converting circuit 21, respectively.

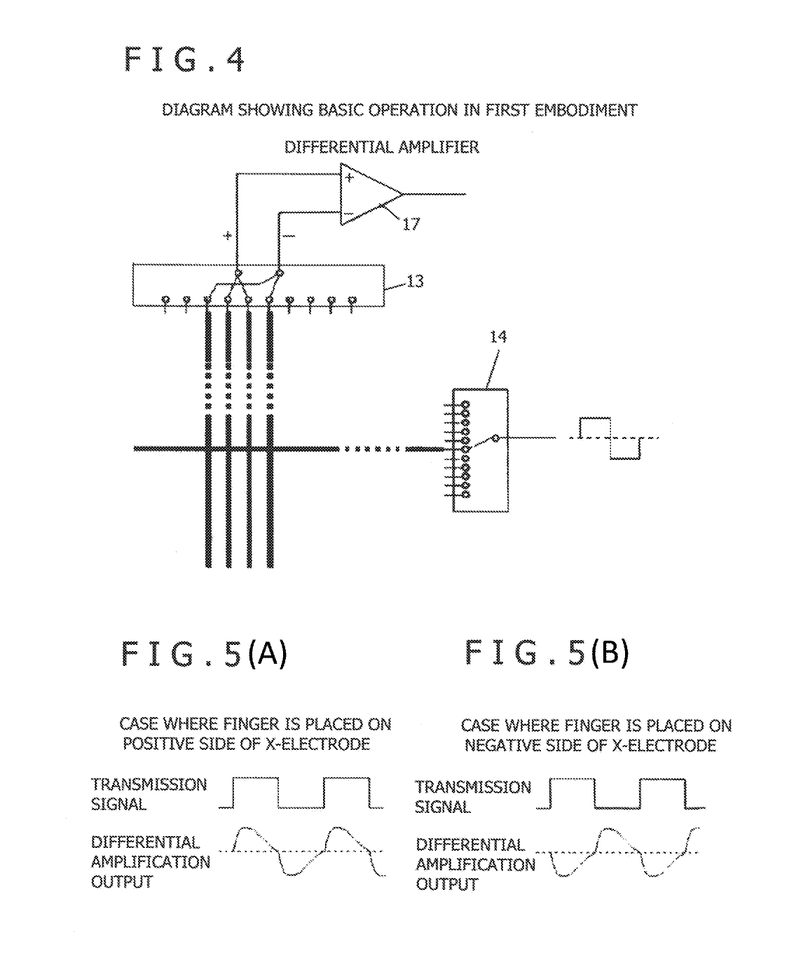

Basic principles of operation in the thus formed present embodiment will first be described. FIG. 4 is a diagram showing a basic operation mode of the present embodiment. The microprocessor 22 sends a control signal to the Y-selecting circuit 14 to select one of the Y-electrodes and connect the Y-electrode to the transmitting circuit 16. In addition, the microprocessor 22 sends a control signal to the X-selecting circuit 13 to select four electrodes adjacent to each other from among the X-electrodes, and connect two central electrodes of the four electrodes to the positive terminal of the X-selecting circuit 13 and connect two electrodes at both ends of the four electrodes to the negative terminal of the X-selecting circuit 13. That is, the microprocessor 22 selects four X-electrodes having consecutive numbers for the X-selecting circuit 13, and selects these four electrodes in order of “−++−.” In this case, “−” in “−++−” denotes connection to the negative terminal of the X-selecting circuit 13. “+” in “−++−” denotes connection to the positive terminal of the X-selecting circuit 13.

At this time, when there is no conductor such as a finger or the like in the vicinity of any of points of intersection of the selected Y-electrode and the four selected X-electrodes, induced voltages generated by these four points of intersection are cancelled out in the differential amplifier 17, and do not appear as output of the differential amplifier 17. However, when a conductor such as a finger or the like is placed on one of the points of intersection, a signal appears from the differential amplifier 17 according to the position of the conductor.

FIGS. 5(A) and 5(B) are diagrams showing a difference between received signals according to the position indicated by the conductor. FIG. 5(A) shows the output signal of the differential amplifier 17 in a case where a conductor is placed on a point of intersection of an X-electrode selected as the positive terminal and a Y-electrode. FIG. 5(B) shows the output signal of the differential amplifier 17 in a case where a conductor is placed on a point of intersection of an X-electrode selected as the negative terminal and a Y-electrode. The output signal of the differential amplifier 17 is thus inverted in phase by 180° depending on whether the conductor is placed on the positive terminal side of the X-electrodes or placed on the negative terminal side of the X-electrodes (that is, whether the conductor is placed on the X-electrode side selected as the positive terminal of the X-selecting circuit 13 or placed on the X-electrode side selected as the negative terminal of the X-selecting circuit 13). As a result of passing such a signal through the synchronous detection circuit 18 and the low-pass filter 19, a positive or negative voltage appears from the low-pass filter 19 according to the position of the indicator.

By reading this voltage as digital data from the AD converting circuit 21, the microprocessor 22 can determine whether the indicator is placed on the positive terminal side of the X-electrodes or placed on the negative terminal side of the X-electrodes.

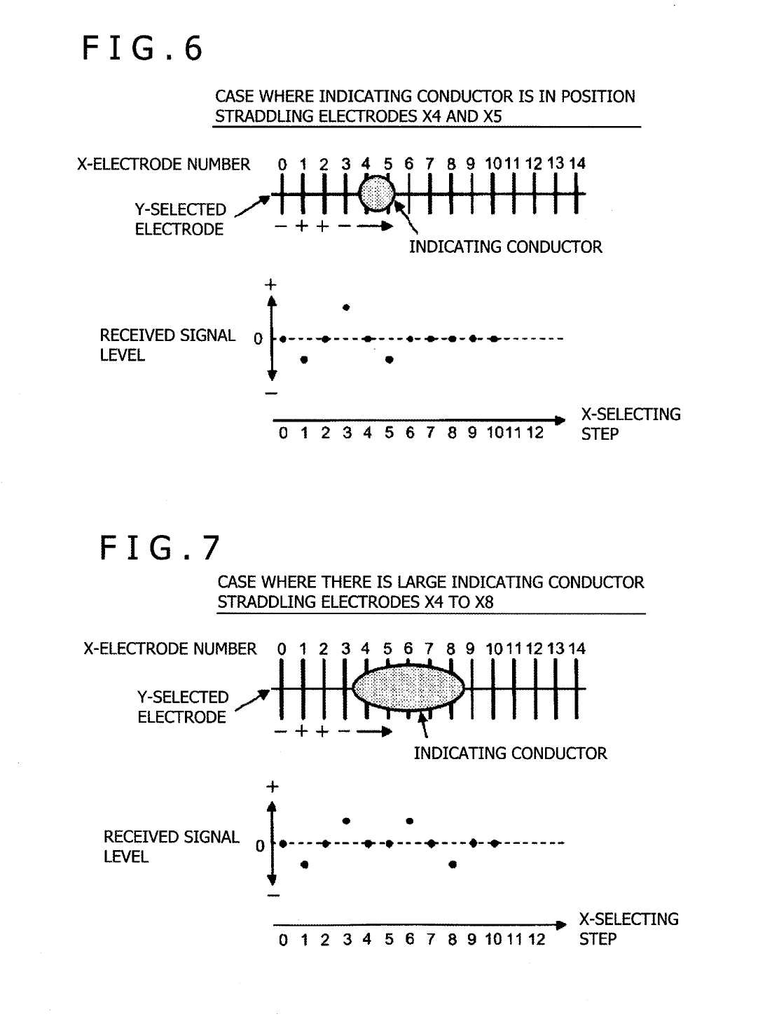

FIG. 6 is a diagram showing how signals are detected in a case where one indicating conductor is placed in a position straddling the electrode X4 and the electrode X5. Suppose that in FIG. 6, the microprocessor 22 selects, as a Y-electrode, exactly a line on which the indicating conductor is placed, and selects four X-electrodes having consecutive numbers in order of “−++−.” Then, the microprocessor 22 increments the selection numbers of the X-electrodes by one each time a step is advanced, by for example selecting the electrodes X0 to X3 in step 0, selecting the electrodes X1 to X4 in step 1, and selecting the electrodes X2 to X5 in step 2.

In this case, the indicating conductor is on an X-electrode selected as the negative terminal side of the X-selecting circuit 13 in step 1 and step 5. The microprocessor 22 therefore detects a signal in a negative direction on the basis of the output of the differential amplifier 17. In addition, in step 3, the indicating conductor is in a position straddling the two X-electrodes selected as the positive terminal side of the X-selecting circuit 13. The microprocessor 22 therefore detects a signal in a positive direction on the basis of the output of the differential amplifier 17. In addition, in step 2 and step 4, the indicating conductor is in a position straddling a positive side electrode and a negative side electrode. Thus, effects of the conductor exactly cancel each other out in the differential amplifier 17, so that the microprocessor 22 does not detect a signal. In the example of FIG. 6, the microprocessor 22 detects a signal in the positive direction in step 3. The indicating conductor is thus recognized to be present in an intermediate position between the electrode X4 and the electrode X5.

FIG. 7 is a diagram showing how signals are detected in a case where such a large indicating conductor as to straddle the electrodes X4 to X8 is placed. Suppose that also in FIG. 7, the microprocessor 22 selects, as a Y-electrode, exactly a line on which the indicating conductor is placed, selects four X-electrodes having consecutive numbers in order of “−++−,” and increments the selection numbers of the X-electrodes by one in each step as in FIG. 6. In this case, in step 1 and step 8, the indicating conductor is on only one X-electrode selected as the negative terminal side of the X-selecting circuit 13. A signal in the negative direction is therefore detected. In addition, in step 2, step 4, step 5, and step 7, the number of X-electrodes selected as the positive terminal side of the X-selecting circuit 13 and included in the region of the indicating conductor is exactly the same as the number of X-electrodes selected as the negative terminal side of the X-selecting circuit 13 and included in the region of the indicating conductor. Thus, effects of the conductor exactly cancel each other out, so that the microprocessor 22 does not detect a signal. In addition, X-electrodes included in the region of the indicating conductor in step 3 and step 6 are one electrode on the negative terminal side of the X-selecting circuit 13 and two electrodes on the positive terminal side of the X-selecting circuit 13. The microprocessor 22 therefore detects a signal in the positive direction. In the example of FIG. 7, as compared with FIG. 6, the signals are detected as if the indicating conductor were present at two positions.

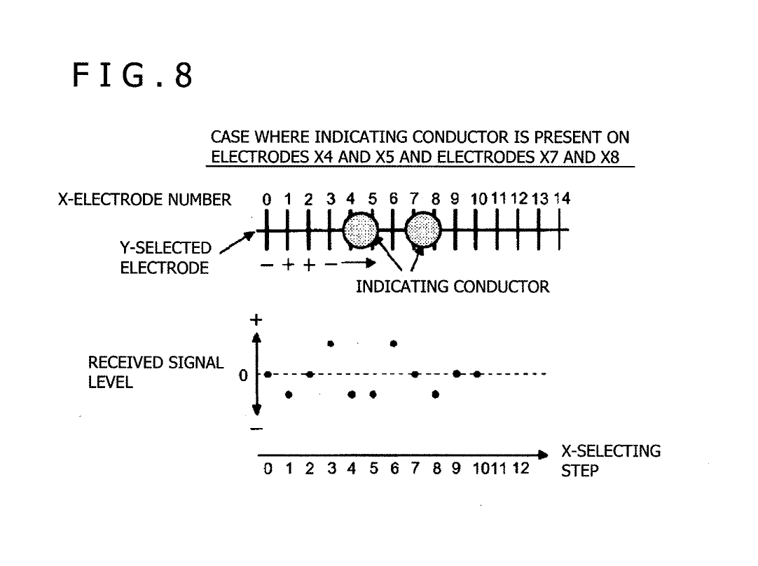

FIG. 8 is a diagram showing how signals are detected in a case where two indicating conductors are placed in a position straddling the electrode X4 and the electrode X5 and in a position straddling the electrode X7 and the electrode X8. Suppose that also in FIG. 8, the microprocessor 22 selects, as a Y-electrode, exactly a line on which the indicating conductors are placed, selects four X-electrodes having consecutive numbers in order of “−++−,” and increments the selection numbers of the X-electrodes by one in each step as in FIG. 6. In this case, in step 1 and step 8, the indicating conductor is on only one X-electrode selected as the negative terminal side of the X-selecting circuit 13. The microprocessor 22 therefore detects a signal in the negative direction. In addition, in step 2 and step 7, one X-electrode on the positive terminal side of the X-selecting circuit 13 and one X-electrode on the negative terminal side of the X-selecting circuit 13 are in the region of the indicating conductor. Therefore no signal appears. In step 3 and step 6, the indicating conductor is present so as to straddle two X-electrodes selected as the positive terminal side of the X-selecting circuit 13, and the indicating conductors are not present on the negative terminal side electrodes. Therefore a signal in the positive direction appears. In step 4 and step 5, X-electrodes included in the regions of the indicating conductors are two X-electrodes on the negative terminal side and one X-electrode on the positive terminal side. A signal in the negative direction is therefore detected.

A comparison between FIG. 7 and FIG. 8 shows that the microprocessor 22 detects a signal in the positive direction in step 3 and step 6, and it therefore appears that two indicating conductors are present in both of FIG. 7 and FIG. 8. However, in FIG. 8, there are steps in which signals in the negative direction appear between two peaks that appear in the positive direction as the X-electrode selecting step is updated, whereas in FIG. 7, the signals in the negative direction do not appear between the two peaks that appear in the positive direction. Thus, in a case where a plurality of peaks in the positive direction appear as the receiving side electrode selecting step is updated in a state of the same transmitting electrode being selected, when there are steps in which signals in the negative direction appear between the peaks, it can be determined that the positive-direction peaks on both sides result from independent indicators, or when there are no steps in which signals in the negative direction appear, it can be determined that the two positive-direction peaks result from a continuous indicator.

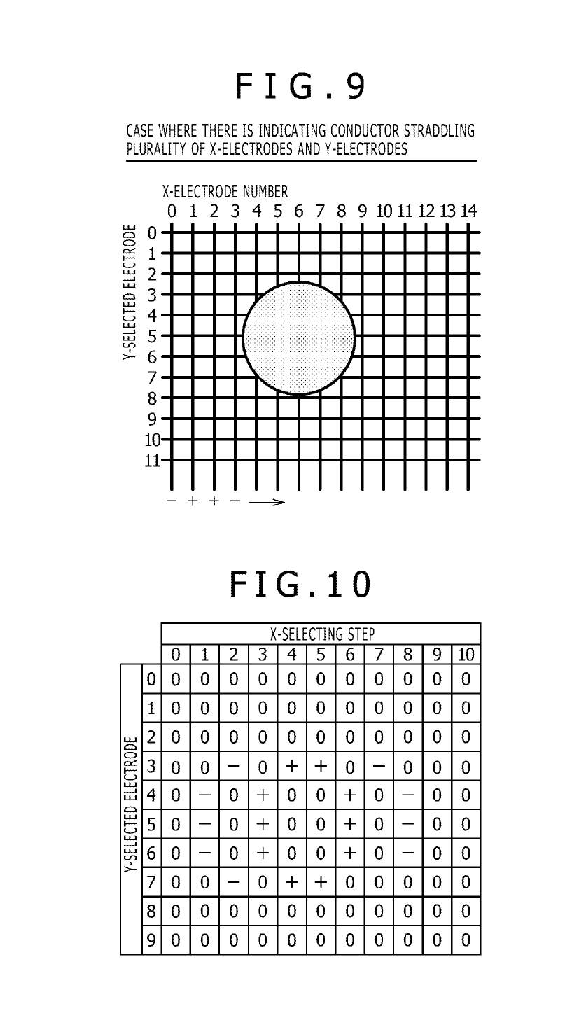

Description will next be made of how signals are detected in a case where an indicating conductor having a relatively large contact surface straddling a plurality of Y-electrodes is placed. FIG. 9 is an example showing positional relation between a contact region when the indicating conductor straddling a plurality of X-electrodes and Y-electrodes is placed and each of the electrodes X and the electrodes Y. FIG. 10 shows the distribution of polarity of voltage output from the low-pass filter 19 when the selection of each of the electrodes X and the electrodes Y is updated in FIG. 9. A vertical direction indicates the selection numbers of the Y-electrodes as the transmitting side. A horizontal direction indicates step numbers when four consecutive X-electrodes are selected in order of “−++−” as in FIG. 6. That is, the microprocessor 22 increments the selection numbers of the X-electrodes by one each time the step is advanced, by for example selecting the electrodes X0 to X3 in step 0, selecting the electrodes X1 to X4 in step 1, and selecting the electrodes X2 to X5 in step 2. In FIG. 10, when the voltage output from the low-pass filter 19 is substantially zero, the voltage is denoted as “0.” When the voltage output from the low-pass filter 19 is a positive voltage, the voltage is denoted as “+.” When the voltage output from the low-pass filter 19 is a negative voltage, the voltage is denoted as “−.”

In FIG. 10, the values of six points in cases where the X-selecting step is step 4 and step 5 while the electrode Y4, the electrode Y5, and the electrode Y6 are selected as a Y-electrode are “0.” However, values displayed on both sides of these values, that is, values in step 3 and step 6 are “+.” The present embodiment therefore regards the values of the six points (values of the six points in the cases of step 4 and step 5) as “+,” and performs processing. Specifically, an average value of the voltages obtained in step 3 and step 6 may be substituted for these values, or higher values in step 3 and step 6 may be substituted. Such processing is performed because as in the above description with reference to FIG. 7, signals in the negative direction do not appear between two peaks that appear in the positive direction as the X-electrode selecting step is updated, and a continuous indicator can therefore be recognized to be placed between the two peaks.

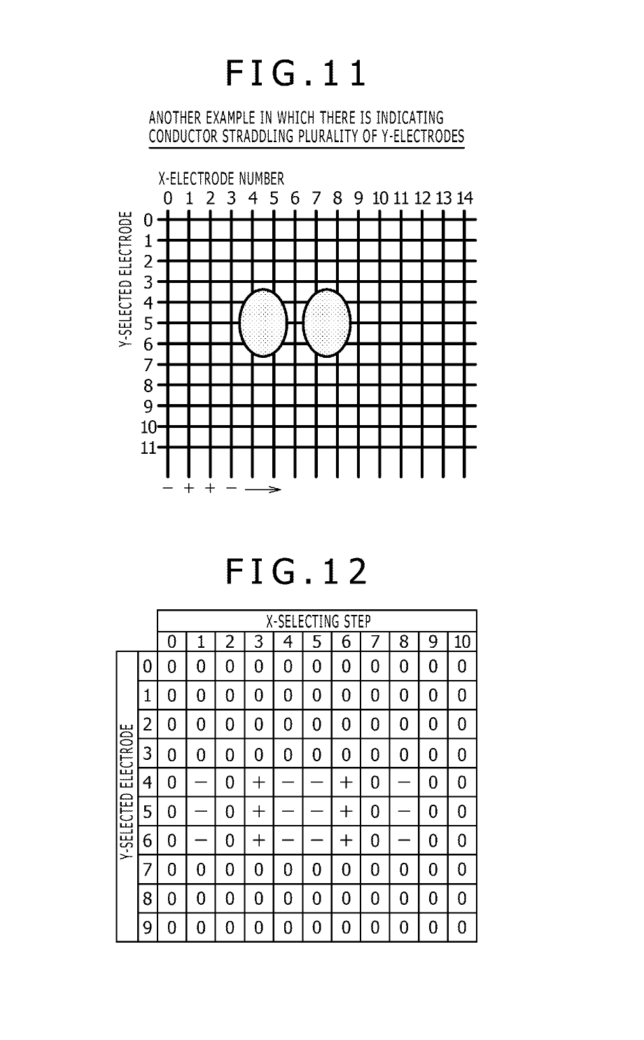

FIG. 11 shows another example in which indicating conductors straddling a plurality of Y-electrodes are placed. FIG. 12 shows, as with FIG. 10, the distribution of polarity of voltage output from the low-pass filter 19 when the selection of each of the electrodes X and the electrodes Y is updated in FIG. 11.

While the electrode Y4, the electrode Y5, and the electrode Y6 are selected as a Y-electrode in FIG. 12, signals in the positive direction appear when the X-selecting step is step 3 and step 6, whereas signals in the negative direction appear in step 4 and step 5 between step 3 and step 6. It is therefore determined that independent indicators are respectively placed in the position of the electrodes X4 and X5 selected as the positive terminal side in step 3 and in the position of the electrodes X7 and X8 selected as the positive terminal side in step 6.

In the present embodiment, the number of X-electrodes selected is four, and the X-electrodes are selected in order of “−++−.” This is an optimum selecting method for properly recognizing fingers in proximity to each other separately even in a case of a large arrangement pitch of the X-electrodes. In addition, the number of X-electrodes selected may be an even number larger than four, that is, for example six, and the X-electrodes may be selected in order of “−+++−−” or “−−+++−,” for example.

In the present embodiment, the number of Y-electrodes selected is one. This is an optimum selecting method for properly recognizing fingers in proximity to each other separately even in a case of a large arrangement pitch of the Y-electrodes. However, two consecutive Y-electrodes or more may be selected.

In the present embodiment, in selecting X-electrodes, both sides of the electrodes selected as the positive terminal side of the X-selecting circuit 13 are selected as the negative terminal side. However, the reverse thereof may be applied.

The present embodiment is configured to regard, as valid, the positive direction of the output voltage of the synchronous detection circuit 18 and the low-pass filter 19 when an indicating conductor is placed on an electrode connected to the non-inverting input terminal (+) of the differential amplifier 17, and regard, as invalid, the negative direction of the output voltage of the synchronous detection circuit 18 and the low-pass filter 19 when an indicating conductor is placed on an electrode connected to the inverting input terminal (−) of the differential amplifier 17. However, a reverse circuit configuration may also be adopted.

### Second Embodiment

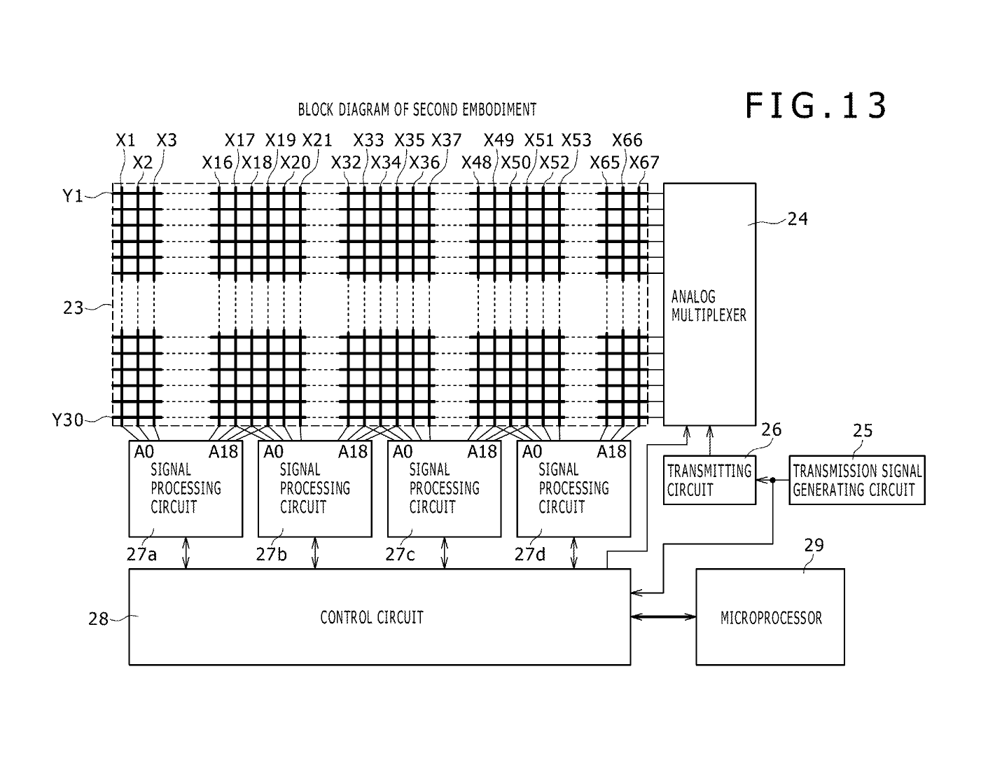

FIG. 13 shows a configuration of a second embodiment of a position detecting device according to the present disclosure. In the present embodiment, a configuration will be shown which is provided with a plurality of circuits that process signals received from receiving electrodes, and which improves a sampling rate as a whole by operating these circuits simultaneously.

A position detecting section in the present embodiment has a structure similar to that of FIG. 1 and FIG. 2. Reference numeral 23 in FIG. 13 denotes a transparent sensor. The transparent sensor has 67 electrodes arranged in an X-direction (X1 to X67), and has 30 electrodes arranged in a Y-direction (Y1 to Y30). Reference numeral 24 denotes an analog multiplexer that is connected to the Y-electrodes of the transparent sensor 23 and which selects one electrode from among the Y-electrodes.

Reference numeral 25 denotes a transmission signal generating circuit that generates a signal having a predetermined frequency. The output signal of the transmission signal generating circuit is supplied to a transmitting circuit 26. The transmitting circuit 26 is a circuit that outputs the signal from the transmission signal generating circuit 25 after converting the signal into a predetermined voltage. The output signal of the transmitting circuit 26 is applied to a Y-electrode selected by the analog multiplexer 24.

Reference numerals 27a to 27d denote respective signal processing circuits having an identical configuration. The signal processing circuits have the same circuits as the X-selecting circuit, the differential amplifier, the synchronous detection circuit, the low-pass filter, the sample and hold circuit, and the AD converting circuit in FIG. 3.

The X-selecting circuits of the signal processing circuits 27a to 27d each have 19 input terminals (A0 to A18). The X-selecting circuits of the signal processing circuits 27a to 27d each select four terminals having consecutive numbers from among these input terminals, and select two terminals at both ends among the four terminals as a negative side and select two central terminals among the four terminals as a positive side.

The terminals on the positive side and the terminals on the negative side which terminals are selected by each of the selecting circuits of the signal processing circuits 27a to 27d are connected to the inputs of the differential amplifier. An output signal from the differential amplifier is passed through the synchronous detection circuit, the low-pass filter, and the sample and hold circuit, and is converted into a digital signal by the AD converting circuit. These operations are the same as the above-described operations in the first embodiment.

Reference numeral 29 denotes a microprocessor that is provided with a read only memory (ROM) and a random access memory (RAM), and which operates according to a predetermined program. The microprocessor controls each of the signal processing circuits 27a to 27d via a control circuit 28, and reads the AD-converted output that is output by each of the signal processing circuits 27a to 27d via the control circuit 28.

The output signal of the transmission signal generating circuit 25 is supplied to the respective synchronous detection circuits of the signal processing circuits 27a to 27d via the control circuit 28.

In the present embodiment, the 67 X-electrodes are connected in a divided state to the 19 input terminals (A0 to A18) of each of the four signal processing circuits 27a to 27d. The input terminals A0 to A18 of the signal processing circuit 27a are connected to the electrodes X1 to X19, respectively. In addition, the input terminals A0 to A18 of the signal processing circuit 27b are connected to the electrodes X17 to X35, respectively.

The input terminals A0 to A1b of the signal processing circuit 27c are connected to the electrodes X33 to X51, respectively. The input terminals A0 to A18 of the signal processing circuit 27d are connected to the electrodes X49 to X67, respectively.

In this case, the number of X-electrodes commonly connected to each of the signal processing circuits 27a and 27b, the signal processing circuits 27b and 27c, and the signal processing circuits 27c and 27d is a number obtained by subtracting one from a total number of X-electrodes selected as the positive terminal and the negative terminal by the X-selecting circuit, and is 4−1=3 in the present example. Specifically, the three electrodes X17 to X19 are commonly connected to the two signal processing circuits 27a and 27b, the three electrodes X33 to X35 are commonly connected to the two signal processing circuits 27b and 27c, and the three electrodes X49 to X51 are commonly connected to the two signal processing circuits 27c and 27d.

The microprocessor 29 has a memory V(x, y) that stores signal level values output from the signal processing circuits 27a to 27d. The memory has 64 x-addresses (1 to 64), and 30 y-addresses (1 to 30).

The microprocessor 29 repeats the operations of steps 1 to 16 to be described in the following.

In starting step 1, the microprocessor 29 controls the control circuit 28 so as to select four electrodes having smallest numbers among the X-electrodes connected to each of the signal processing circuits 27a to 27d in order of “−++−.” That is, the signal processing circuit 27a selects the electrodes X1 to X4, the signal processing circuit 27b selects the electrodes X17 to X20, the signal processing circuit 27c selects the electrodes X33 to X36, and the signal processing circuit 27d selects the electrodes X49 to X52.

Step 1 is further divided into 30 processing periods. In a first processing period of step 1, the analog multiplexer 24 selects the electrode Y1, and a transmission signal from the transmitting circuit 26 is supplied to the electrode Y1. At this time, the microprocessor 29 reads, from each of the signal processing circuits 27a to 27d via the control circuit 28, a signal level value output via the synchronous detection circuit, the low-pass filter, the sample and hold circuit, and the AD converting circuit after differential amplification of signals from the above-described selected X-electrodes.

Next, in a second processing period of step 1, the analog multiplexer 24 selects the electrode Y2, and the microprocessor 29 reads a signal level output from each of the signal processing circuits 27a to 27d. Similarly, in a third processing period, the analog multiplexer 24 selects the electrode Y3, and the microprocessor 29 reads a signal level output from each of the signal processing circuits 27a to 27d. The microprocessor 29 thus reads signal levels while sequentially updating the selection number of the Y-electrode. In a thirtieth processing period, the electrode Y30 is selected, and signal levels are read.

At this time, the microprocessor 29 stores the 30 signal levels read from the signal processing circuit 27a in the memory V(1, 1) to V(1, 30) within the microprocessor 29 in order. In addition, the microprocessor 29 stores the 30 signal levels read from the signal processing circuit 27b in the memory V(17, 1) to V(17, 30) in order. In addition, the microprocessor 29 stores the 30 signal levels read from the signal processing circuit 27c in the memory V(33, 1) to V(33, 30) in order. In addition, the microprocessor 29 also stores the 30 signal levels read from the signal processing circuit 27d in the memory V(49, 1) to V(49, 30) in order.

Next, in starting step 2, the microprocessor 29 controls the control circuit 28 so as to advance the numbers of the X-electrodes selected by each of the signal processing circuits 27a to 27d by one from the numbers at the time of the above-described step 1. That is, the signal processing circuit 27a selects the electrodes X2 to X5, the signal processing circuit 27b selects the electrodes X18 to X21, the signal processing circuit 27c selects the electrodes X34 to X37, and the signal processing circuit 27d selects the electrodes X50 to X53.

Also in step 2, as in step 1, the microprocessor 29 reads signal levels from the respective signal processing circuits 27a to 27d when the analog multiplexer 24 sequentially selects the electrodes Y1 to Y30. At this time, the microprocessor 29 stores the 30 signal levels read from the signal processing circuit 27a in the memory V(2, 1) to V(2, 30) in order. In addition, the microprocessor 29 stores the 30 signal levels read from the signal processing circuit 27b in the memory V(18, 1) to V(18, 30) in order. In addition, the microprocessor 29 stores the 30 signal levels read from the signal processing circuit 27c in the memory V(34, 1) to V(34, 30) in order. In addition, the microprocessor 29 also stores the 30 signal levels read from the signal processing circuit 27d in the memory V(50, 1) to V(50, 30) in order.

In next step 3, the numbers of the X-electrodes selected by the signal processing circuits 27a to 27d are advanced by one from the numbers at the time of step 2. The signal processing circuit 27a selects the electrodes X3 to X6, the signal processing circuit 27b selects the electrodes X19 to X22, the signal processing circuit 27c selects the electrodes X35 to X38, and the signal processing circuit 27d selects the electrodes X51 to X54. Signal levels are similarly read. The signal levels read from the respective signal processing circuits 27a to 27d are stored in the memory V(3, 1) to V(3, 30), the memory V(19, 1) to V(19, 30), the memory V(35, 1) to V(35, 30), and the memory V(51, 1) to V(51, 30), respectively.

Similarly, each time the step number is updated, the selection numbers of the X-electrodes are advanced by one, and signal levels from the respective signal processing circuits 27a to 27d are read. In last step 16, signal levels read from the respective signal processing circuits 27a to 27d are stored in the memory V(16, 1) to V(16, 30), the memory V(32, 1) to V(32, 30), the memory V(48, 1) to V(48, 30), and the memory V(64, 1) to V(64, 30), respectively.

The present embodiment can thus obtain signal levels when the number of the Y-side selected electrode is “y” and the numbers of the X-side selected electrodes are “x to x+3” as V(x, y) in steps 1 to 16. The thus obtained signal levels assume a positive or negative value as in the first embodiment. Thus, the positions and number of indicators can be obtained by a method similar to that described with reference to FIGS. 6 to 12.

The present embodiment divides the position detecting surface into the four regions and performs processing by the four signal processing circuits. The present embodiment can thereby obtain the signal levels of the entire surface in a short time.

In addition, because X-electrodes located in the vicinity of a boundary between regions are commonly connected to two signal processing circuits, signals are detected in the same manner as in a case of a continuous detecting surface as a whole. In addition, even when each individual signal processing circuit is configured as an integrated circuit (IC), processing can be performed with the divided position detecting surface treated as a continuous detecting surface, without the presence of a non-sensitive region.

It is to be noted that while the number of divisions of the position detecting surface in the present embodiment is four, the number of divisions of the position detecting surface is not limited to this, but may be larger than four, or may be smaller than four.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### DESCRIPTION OF REFERENCE SYMBOLS

11 . . . LCD panel
12, 23 . . . Transparent sensor
13 . . . X-selecting circuit
14 . . . Y-selecting circuit
15 . . . Oscillator
16, 26 . . . Transmitting circuit
17 . . . Differential amplifier
18 . . . Synchronous detection circuit
19 . . . Low-pass filter
20 . . . Sample and hold circuit
21 . . . AD converting circuit
22, 29 . . . Microprocessor
24 . . . Analog multiplexer
25 . . . Transmission signal generating circuit
27 . . . Signal processing circuit
28 . . . Control circuit

1. A position detecting device comprising:
a position detecting sensor having a plurality of electrodes arranged in a first direction and a plurality of electrodes arranged in a second direction orthogonal to the first direction;
a transmission signal generating circuit which, in operation, generates a transmission signal;
a first electrode selecting circuit which, in operation, supplies the transmission signal generated by the transmission signal generating circuit to a predetermined electrode among the plurality of electrodes arranged in the first direction;
a differential amplifier circuit having a first input terminal and a second input terminal, wherein the differential amplifier circuit, in operation, outputs a signal obtained by differentially amplifying signals input to the first input terminal and the second input terminal;
a second electrode selecting circuit which, in operation, selects a number of electrodes adjacent to each other among the plurality of electrodes arranged in the second direction, the number of electrodes adjacent to each other being four or more and being an even number, connects one half of the even number of electrodes selected, the one half including electrodes adjacent to each other and not including electrodes at both ends of the even number of electrodes selected, to the first input terminal of the differential amplifier circuit, and connects a remaining half of the even number of electrodes selected, the remaining half including the electrodes at both ends of the even number of electrodes selected, to the second input terminal of the differential amplifier circuit;
a synchronous detection circuit which, in operation, detects a strength of the signal output by the differential amplifier circuit, and outputs a signal in a positive direction or a negative direction according to a phase of the signal with respect to a phase of the transmission signal; and
a processing circuit which, in operation, determines a position indicated by an indicating conductor according to a distribution of strength of the signal output by the synchronous detection circuit and a polarity of the signal output by the synchronous detection circuit, the polarity being expressed as positive polarity or a negative polarity, when the electrodes selected by the first electrode selecting circuit and the second electrode selecting circuit are sequentially changed.

2. The position detecting device according to claim 1,
wherein the processing circuit, in operation, performs processing that regards, as valid, a direction of the polarity of the signal output from the synchronous detection circuit when the indicating conductor is placed on an electrode connected to the first input terminal of the differential amplifier circuit by the second electrode selecting circuit, and that regards, as invalid, the direction of the polarity of the signal output from the synchronous detection circuit when the indicating conductor is placed on an electrode connected to the second input terminal of the differential amplifier circuit by the second electrode selecting circuit.

3. The position detecting device according to claim 1,
wherein, after the electrodes selected by the second electrode selecting circuit are updated in order while the first electrode selecting circuit supplies the transmission signal generated by the transmission signal generating circuit to the predetermined electrode, and, when a distribution of output voltages from the synchronous detection circuit has two peak voltages in the positive direction and a voltage in the negative direction of a predetermined magnitude or more is present between the two peak voltages, the processing circuit, in operation, determines that two independent indicating conductors caused the two peak voltages.

4. The position detecting device according to claim 1,
wherein the number of electrodes selected by the second electrode selecting circuit is four.

5. A position detecting device comprising:
a position detecting sensor including a plurality of transmitting electrodes arranged in a first direction of a position detecting surface and a plurality of receiving electrodes arranged in a second direction orthogonal to the first direction, the position detecting device detecting a signal corresponding to a change in capacitance between the transmitting electrodes and the receiving electrodes when an indicating conductor comes into contact with the position detecting surface;
a plurality of signal processing circuits each connected to a predetermined number of electrodes among the plurality of receiving electrodes
wherein each of the plurality of signal processing circuits includes an electrode selecting circuit which, in operation, selects two sets of electrodes from among the predetermined number of electrodes among the plurality of receiving electrodes and connects the two sets of electrodes to a positive terminal and a negative terminal, respectively, and a differential amplifier circuit connected to the positive terminal and the negative terminal, wherein the differential amplifier circuit, in operation, detects a difference between a signal supplied to the positive terminal and a signal supplied to the negative terminal, and
wherein the position detecting surface is divided into a plurality of regions in the second direction and the receiving electrodes are connected to each of the plurality of signal processing circuits in each region, and a particular number of receiving electrodes located in a vicinity of a boundary between regions are commonly connected to two of the plurality of signal processing circuits.

6. The position detecting device according to claim 5,
wherein the particular number is one less than a total number of electrodes selected and connected to the positive terminal and the negative terminal by each electrode selecting circuit.

7. The position detecting device according to claim 5,
wherein, in each of the plurality of signal processing circuits, a number of electrodes connected to the positive terminal by the electrode selecting circuit and a number of electrodes connected to the negative terminal by the electrode selecting circuit are equal to each other and are two or more, and the electrode selecting circuit connects electrodes adjacent to each other to a first one of the positive terminal and the negative terminal and connects to a second one of the positive terminal and the negative terminal, electrodes distributed on both sides of the electrodes connected to the first one of the positive terminal and the negative terminal.

8. The position detecting device according to claim 5,
wherein each of the signal processing circuits is housed in one integrated circuit (IC).

9. The position detecting device according claim 5,
wherein the electrodes arranged in the first direction and the second direction are formed by using a transparent conductive material, and the position detecting sensor is combined with a display device.

10. The position detecting device according to claim 1,
wherein, after the electrodes selected by the second electrode selecting circuit are updated in order while the first electrode selecting circuit supplies the transmission signal generated by the transmission signal generating circuit to the predetermined electrode, and, when a distribution of output voltages from the synchronous detection circuit has two peak voltages in the positive direction and a voltage in the negative direction of a predetermined magnitude or more is not present between the two peak voltages, the processing circuit, in operation, determines that a single indicating conductor caused the two peak voltages.

11. The position detecting device according to claim 1,
wherein, after the electrodes selected by the second electrode selecting circuit are updated in order while the first electrode selecting circuit supplies the transmission signal generated by the transmission signal generating circuit to the predetermined electrode, and, when a distribution of output voltages from the synchronous detection circuit has two peak voltages in the negative direction and a voltage in the positive direction of a predetermined magnitude or more is present between the two peak voltages, the processing circuit, in operation, determines that two independent indicating conductors caused the two peak voltages.

12. The position detecting device according to claim 1,
wherein, after the electrodes selected by the second electrode selecting circuit are updated in order while the first electrode selecting circuit supplies the transmission signal generated by the transmission signal generating circuit to the predetermined electrode, and, when a distribution of output voltages from the synchronous detection circuit has two peak voltages in the negative direction and a voltage in the positive direction of a predetermined magnitude or more is not present between the two peak voltages, the processing circuit, in operation, determines that a single indicating conductor caused the two peak voltages.

13. The position detecting device according claim 1,
wherein the electrodes arranged in the first direction and the second direction are formed by using a transparent conductive material, and the position detecting sensor is combined with a display device.

14. A method of operating a position detecting device that includes a plurality of electrodes arranged in a first direction, a plurality of electrodes arranged in a second direction orthogonal to the first direction, and a differential amplifier circuit having a first input terminal and a second input terminal, wherein the differential amplifier circuit, in operation, outputs a signal obtained by differentially amplifying signals input to the first input terminal and the second input terminal, the method comprising:
generating a transmission signal;
supplying the transmission signal to a predetermined electrode among the plurality of electrodes arranged in the first direction;
selecting an even number of electrodes adjacent to each other among the plurality of electrodes arranged in the second direction, the even number being four or more;
connecting a first half of the selected even number of electrodes to the first input terminal of the differential amplifier circuit, the first half including electrodes adjacent to each other and not including electrodes at both ends of the selected even number of electrodes;
connecting a second half of the selected even number of electrodes to the second input terminal of the differential amplifier circuit, the second half including the electrodes at both ends of the selected even number of electrodes;
outputting a synchronous detection signal in a positive direction or a negative direction according to a phase of the signal output by the differential amplifier circuit with respect to a phase of the transmission signal; and
determining a position indicated by an indicating conductor according to a distribution of strength of the synchronous detection signal and a polarity of the synchronous detection signal, the polarity being expressed a positive polarity or a negative polarity.

15. The method of claim 14, comprising:
performing processing that regards, as valid, a direction of the polarity of the synchronous detection signal when the indicating conductor is placed on an electrode connected to the first input terminal of the differential amplifier, and that regards, as invalid, the direction of the polarity of the synchronous detection signal when the indicating conductor is placed on an electrode connected to the second input terminal of the differential amplifier circuit.

16. The method of claim 14, comprising:
updating the selected even number of electrodes while supplying the transmission signal to the predetermined electrode among the plurality of electrodes arranged in the first direction; and
detecting two independent indicating conductors in response to determining that a voltage distribution of the synchronous detection signal has two peak voltages in the positive direction and determining that a voltage in the negative direction of a predetermined magnitude or more is present between the two peak voltages.

17. The method of claim 14, comprising:
updating the selected even number of electrodes while supplying the transmission signal to the predetermined electrode among the plurality of electrodes arranged in the first direction; and
detecting a single indicating conductor in response to determining that a voltage distribution of the synchronous detection signal has two peak voltages in the positive direction and determining that a voltage in the negative direction of a predetermined magnitude or more is not present between the two peak voltages.

18. The method of claim 14, comprising:
updating the selected even number of electrodes while supplying the transmission signal to the predetermined electrode among the plurality of electrodes arranged in the first direction; and
detecting two independent indicating conductors in response to determining that a voltage distribution of the synchronous detection signal has two peak voltages in the negative direction and determining that a voltage in the positive direction of a predetermined magnitude or more is present between the two peak voltages, the processing circuit.

19. The method of claim 14, comprising:
updating the selected even number of electrodes while supplying the transmission signal to the predetermined electrode among the plurality of electrodes arranged in the first direction; and
detecting a single indicating conductor in response to determining that a voltage distribution of the synchronous detection signal has two peak voltages in the negative direction and determining that a voltage in the positive direction of a predetermined magnitude or more is not present between the two peak voltages, the processing circuit.

20. The method of claim 14,
wherein connecting the first half of the selected even number of electrodes to the first input terminal of the differential amplifier circuit includes connecting two of the plurality of electrodes arranged in the second direction to the first input terminal of the differential amplifier circuit; and
wherein connecting the second half of the selected even number of electrodes to the second input terminal of the differential amplifier circuit includes connecting two of the plurality of electrodes arranged in the second direction to the second input terminal of the differential amplifier circuit.
